(19) United States
(12) Patent Application Publication
(10) Pub. No.: US 2014/0184518 A1
(43) Pub. Date: Jul. 3, 2014

(54) VARIABLE TOUCH SCREEN SCANNING RATE BASED ON USER PRESENCE DETECTION

(71) Applicant: John J. Valavi, Hillsboro, OR (US)

(72) Inventor: John J. Valavi, Hillsboro, OR (US)

(21) Appl. No.: 13/729,319

(22) Filed: Dec. 28, 2012

(51) Int. Cl. G06F 3/041

(52) U.S. Cl. CPC G06F 3/041
USPC 345/173

(57) ABSTRACT

Methods and apparatus relating to variable touch screen scanning rate based on user presence detection are described. In one embodiment, the scan rate of a touch screen is modified based on proximity data. The proximity data indicates the proximity of a user to the touch screen. The proximity data is generated by one or more proximity sensors that are communicatively coupled (e.g., via a scan rate control logic) to the touch screen. Other embodiments are also disclosed and claimed.

### FIELD

The present disclosure generally relates to the field of electronics. More particularly, an embodiment of the invention relates to variable touch screen scanning rate based on user presence detection.

### BACKGROUND

As integrated circuit (IC) fabrication technology improves, manufacturers are able to integrate additional functionality onto a single silicon substrate. As the number of these functionalities increases, however, so does the number of components on a single IC chip. Additional components add additional signal switching, in turn, generating more heat. The additional heat may damage an IC chip by, for example, thermal expansion. Also, the additional heat may limit usage locations and/or usage applications of a computing device that includes such chips.

For example, a portable computing device may solely rely on battery power for its operations. Hence, as additional functionality is integrated into portable computing devices, the need to reduce power consumption becomes increasingly important, for example, to maintain battery power for an extended period of time. Non-portable computing systems also face cooling and power consumption issues as their IC components use more power and generate more heat.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 4, and 5 illustrate block diagrams of embodiments of computing systems, which may be utilized to implement various embodiments discussed herein.

FIG. 2 illustrates a block diagram of computing system components, according to some embodiments.

FIG. 3 illustrates a flow diagram according to some embodiments.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Generally, touch screens consume power based on the scanning rate used for scanning touch. As the scanning rates increase (e.g., to provide faster and better touch detection), the power consumption also increases. Some manufacturer/vendors may only utilize a lower scan rate based on a timer. More particularly, based on the time elapsed from the last touch by a user, the touch screen enters a fixed lower scanning rate. If a manufacturer/vendor aggressively modifies or decreases the scanning rate, the user experience is affected. The touch screen will be slower in detecting the finger touch and hence the user will feel that the touch screen is not responsive.

Furthermore, Always On Always Connected (AOAC) used in mobile devices (such as tablets, phones, etc.) drive the usage mode of keeping computers on all the time. Such features allow a mobile device to continue power consumption even when idle. This can have a significant negative effect on the battery life of a mobile device, and, due to the existing and projected number of mobile devices, may also pose a significant environmental impact through CO2 emissions.

To this end, some of the embodiments discussed herein provide efficient and flexible power management for components of computing systems (including components of mobile devices (such as phones, tablets, UMPC (Ultra-Mobile Personal Computer), laptop computers (such as ultrabooks), etc.)). For example, such techniques may be applied to various components such as touch screens, touch pads, backlight for keyboards, and/or processors (including general purpose processors, graphics processors, etc.) based on user proximity to the computing system. In an embodiment, a proximity sensor (also referred to herein as a “presence detector” interchangeable) detects how close a user's hand is to a touch screen. Based on the proximity of the user's hand, the scanning rate for the touch screen is varied. Since some embodiments use the location of the user's hand compared to the touch screen, the touch screen will have better response and better power savings, when compared to a timer only technique.

For example, if the user's hand is not even detected to be in range by the proximity sensor, the touch screen can enter the lowest available power state, e.g., to activate the lowest scanning rate. Moreover, once the user enters the field of view of the proximity sensor, the touch screen can start the scanning and based on the location of the hand in relation to the touch screen, the touch screen can enter a higher available power state, e.g., to activate a higher available scanning rate. While some embodiments are discussed with reference to only two (e.g., high and low) scanning rates, some implementations may utilize more than two scanning rates.

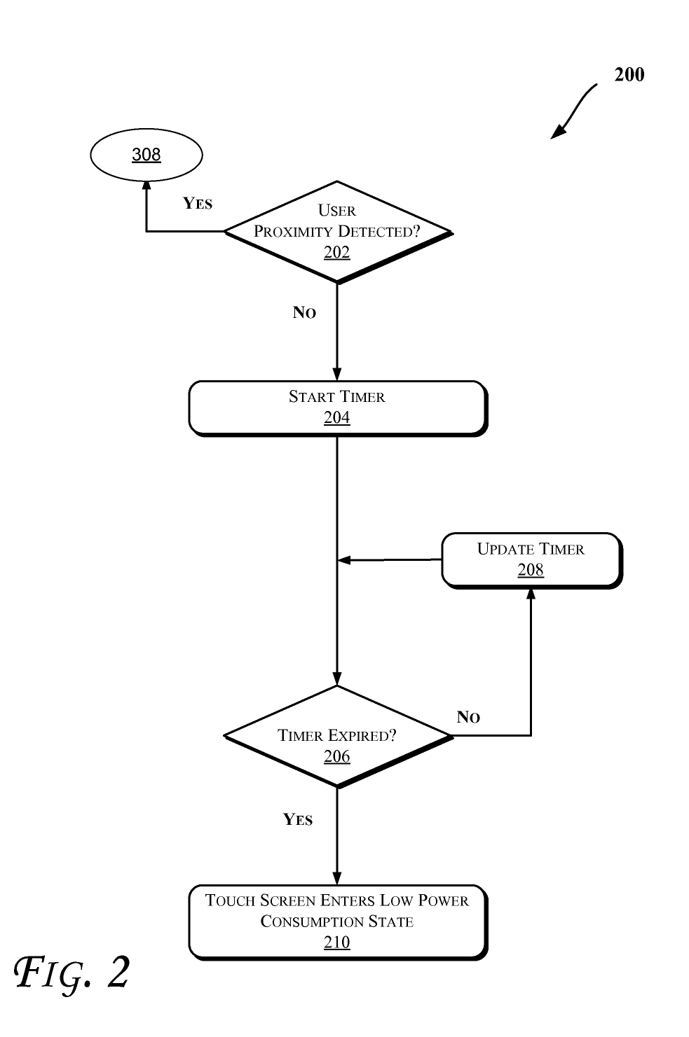

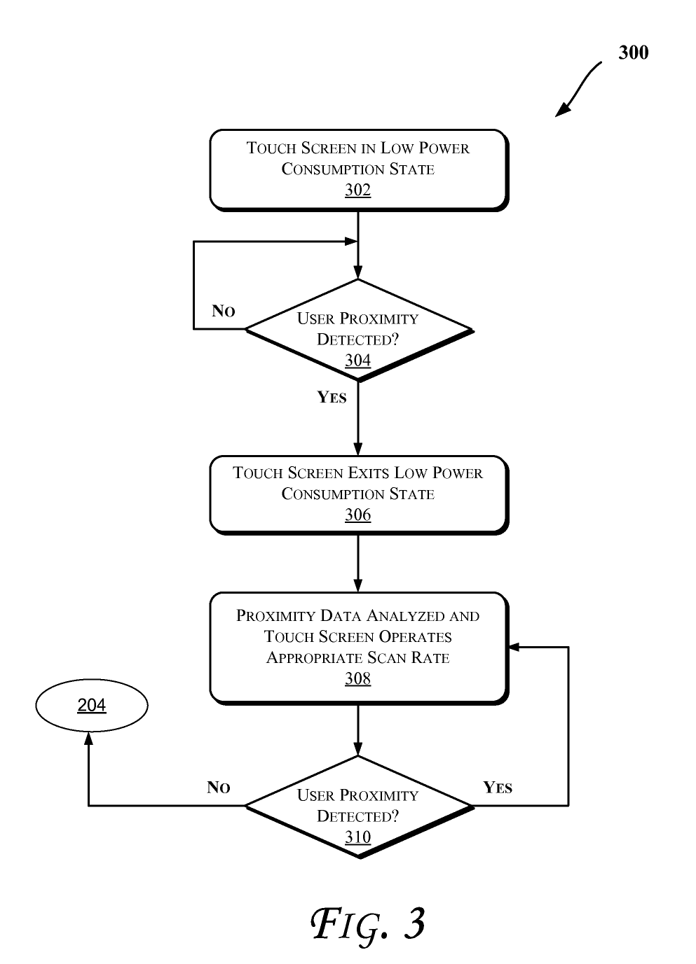

Additionally, user proximity detection may be used to change the power consumption state of a computing system (e.g., the platform power consumption state or the power consumption state of one or more of its processors (including general purpose processors, graphics processors, etc.)). For example, if a user is not detected as being proximate to the device (such as discussed with reference to FIG. 2), the device may be put in a low power consumption state (such as sleep, deep sleep, suspend, etc.). Once user proximity is detected (e.g., as discussed with reference to FIG. 3), the device may enter a higher power consumption state (such as C0). Also, in some embodiments, at least some of the power consumption states discussed herein may be in accordance with or similar to those defined under Advanced Configuration and Power Interface (ACPI) specification, Revision 4.0a, Apr. 5, 2010.

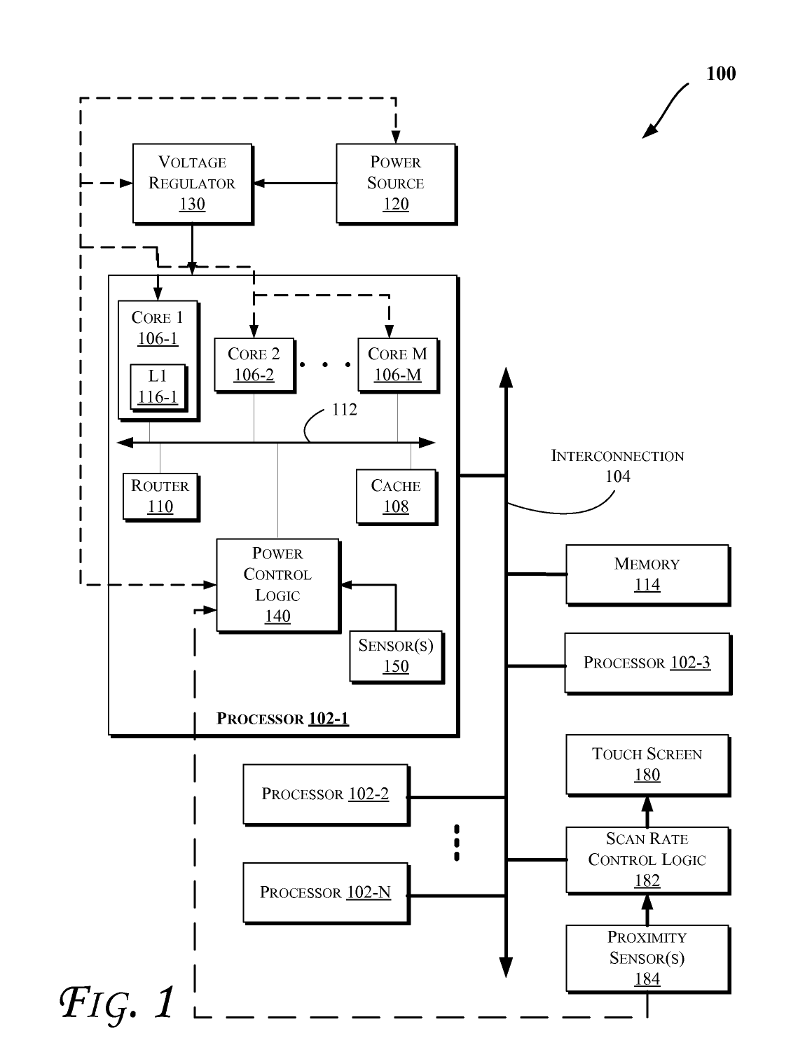

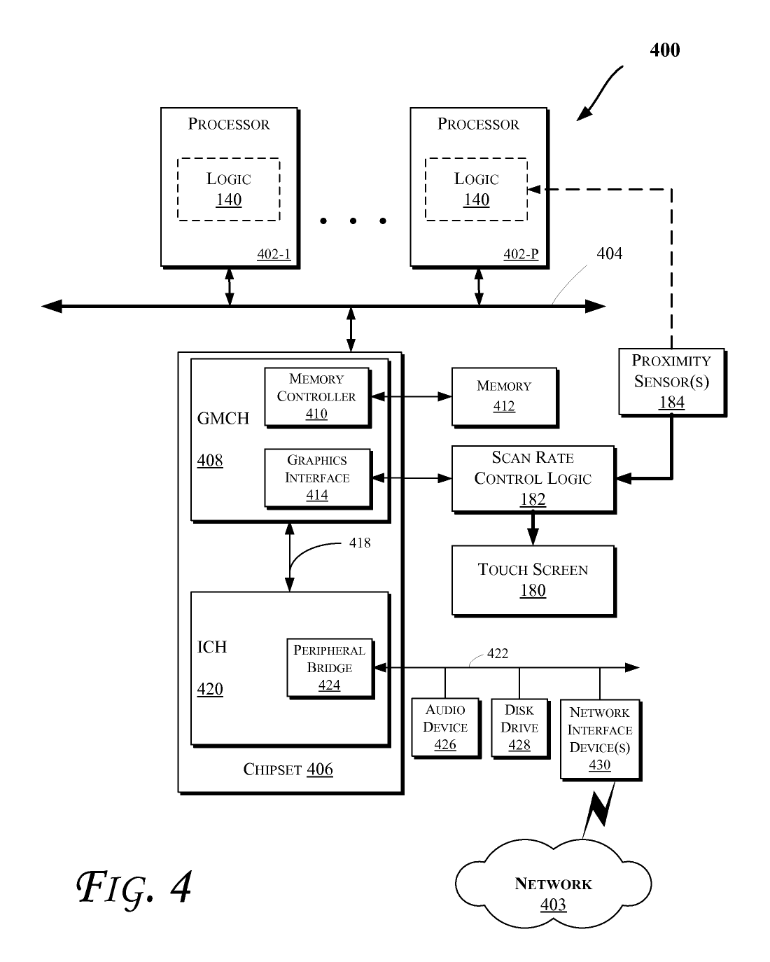

Moreover, the proximity sensor(s) may detect a user's proximity based on captured scenes, images, or frames (e.g., which may be processed by the graphics logic in various embodiments) that are captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the images/frames in the scene are designed/generated on a computing device in some embodiments. Also, one or more of the images/frames of the scene may be presented via a display (such as the display discussed with reference to FIGS. 1, 4, and/or 5, including for example a flat panel display device, etc.).

Moreover, some embodiments may be applied in computing systems that include one or more processors (e.g., with one or more processor cores), such as those discussed with reference to FIGS. 1-5. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

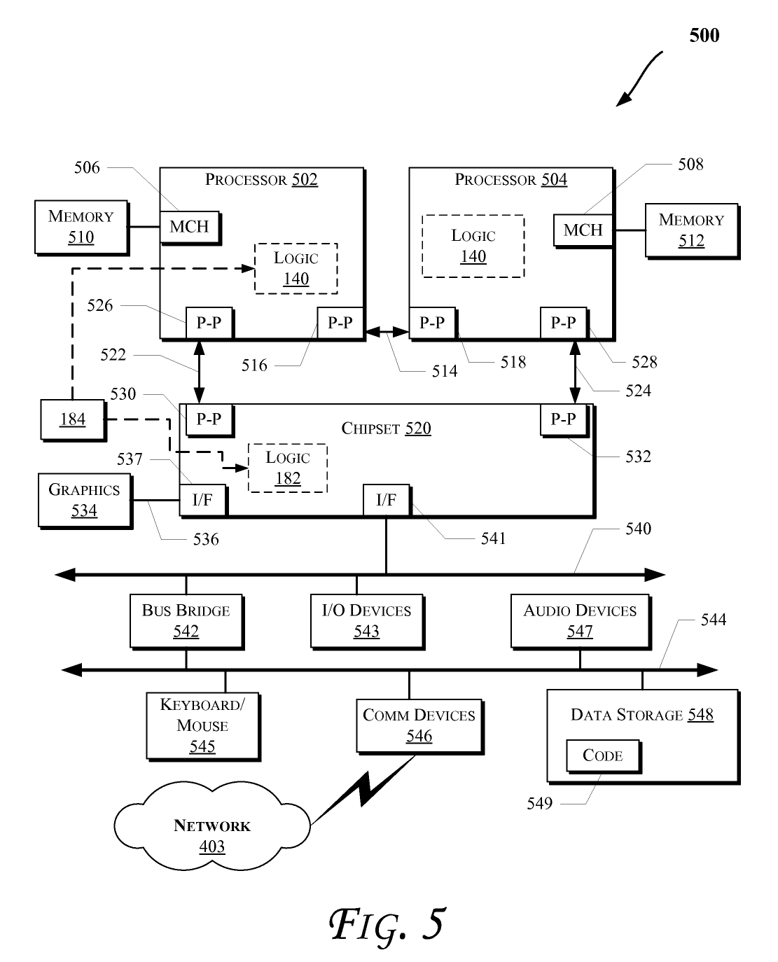

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 4-5), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a platform power source 120 (e.g., a direct current (DC) power source or an alternating current (AC) power source) to provide power to one or more components of the system 100. In some embodiments, the power source 120 may include one or more battery packs and/or power supplies. The power source 120 may be coupled to components of system 100 through a voltage regulator (VR) 130. Moreover, even though FIG. 1 illustrates one power source 120 and one voltage regulator 130, additional power sources and/or voltage regulators may be utilized. For example, one or more of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores).

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102.

As shown in FIG. 1, the processor 102 may further include a power control logic 140 to control supply of power to components of the processor 102 (e.g., cores 106). Logic 140 may have access to one or more storage devices discussed herein (such as cache 108, L1 cache 116, memory 114, or another memory in system 100) to store information relating to operations of logic 140 such as information communicated with various components of system 100 as discussed here. As shown, the logic 140 may be coupled to the VR 130 and/or other components of system 100 such as the cores 106 and/or the power source 120.

For example, the logic 140 may be coupled to receive information (e.g., in the form of one or more bits or signals) to indicate status of one or more sensors 150. The sensor(s) 150 may be provided proximate to components of system 100 (or other computing systems discussed herein such as those discussed with reference to other figures including 4 and 5, for example), such as the cores 106, interconnections 104 or 112, components outside of the processor 102, etc., to sense variations in various factors affecting power/thermal behavior of the system/platform, such as temperature, operating frequency, operating voltage, power consumption, and/or inter-core communication activity, etc.

The logic 140 may in turn instruct the VR 130, power source 120, and/or individual components of system 100 (such as the cores 106) to modify their operations. For example, logic 140 may indicate to the VR 130 and/or power source 120 to adjust their output. In some embodiments, logic 140 may request the cores 106 to modify their operating frequency, power consumption, etc. Also, even though components 140 and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, etc. Furthermore, as shown in FIG. 1, the power source 120 and/or the voltage regulator 130 may communicate with the power control logic 140 and report their power specification.

As shown in FIG. 1, system 100 also includes a touch screen 180 to detect user touch input. The touch screen 180 (which may be attached to a display device to display images in some embodiments) is coupled to the interconnection 104 via a scan rate control logic 182 that controls the scan rate used for the touch screen 180, e.g., based on proximity data detected at the proximity sensor(s) 184 (which are communicatively coupled to the logic 182 to transmit the detected proximity data). Sensor(s) 184 may be any type of sensor capable of detecting proximity such as an infra red sensor, ultra sonic device, efield based proximity sensor, an image capture device (such as a digital camera), etc. As shown, logic 140 may also receive proximity data from the proximity sensor(s) 184 to determine proximity of a user to the system and in response adjust the power consumption state of various components of system 100 as discussed herein.

FIG. 2 illustrates a flow diagram of an embodiment of a method 200 to reduce the scan rate of a touch screen, according to some embodiments. In an embodiment, various components discussed with reference to FIGS. 1 and 4-5 may be utilized to perform one or more of the operations discussed with reference to FIG. 2 (including for example logic 180).

Referring to FIGS. 1-2, at an operation 202, it is determined whether user proximity is detected (e.g., by the sensor(s) 184). If no proximity is detected, method 200 continues at operation 308 of FIG. 3. Otherwise, a timer/counter is started at an operation 204. The timer/counter may keep track of time lapsed since the last touch detected at the touch screen 180 by the user. At an operation 206, it is determined whether the timer has lapsed/expired (of if using a counter whether the counter has reached a threshold value). If not, the timer/counter is updated/incremented at operation 208. Once the timer expires, the touch screen (e.g., touch screen 180) enters a low power consumption state (such as standby, sleep, deep sleep, suspend (e.g., to Random Access Memory (RAM), while power is maintained to RAM to maintain data correctness), etc.) and/or the scan rate of the touch screen is reduced to reduce power consumption. Operations 204-208 are optional and may or may not be present in various embodiments.

FIG. 3 illustrates a flow diagram of an embodiment of a method 300 to increase the scan rate of a touch screen, according to some embodiments. In an embodiment, various components discussed with reference to FIGS. 1 and 4-5 may be utilized to perform one or more of the operations discussed with reference to FIG. 3 (including for example logic 180).

Referring to FIGS. 1-3, at an operation 302, the touch screen (e.g., touch screen 180) is in a low power consumption state such as standby, sleep, deep sleep, suspend (e.g., to RAM, while power is maintained to RAM to maintain data correctness), etc.) Once user proximity is detected at operation 304 (e.g., detected by the sensor(s) 184 and conveyed to the logic 182 via an indication such as a message or a signal), the touch screen exits the lower power consumption state at an operation 306 (e.g., at the direction of the logic 182).

At an operation 308, method 300 continues to analyze the proximity data and adjusts the scan rate of the touch screen 180 (e.g., logic 182 analyzes the data detected by the sensor(s) 184) as long as user proximity is detected at operation 310. Once no more user proximity is detected at operation 310, method 300 resumes with operation 204 of FIG. 2 or alternatively go to sleep mode or a lower power consumption state.

FIG. 4 illustrates a block diagram of a computing system 400 in accordance with an embodiment of the invention. The computing system 400 may include one or more central processing unit(s) (CPUs) or processors 402-1 through 402-P (which may be referred to herein as “processors 402” or “processor 402”). The processors 402 may communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. In some embodiments, system 400 may include one or more of the cores 106, logic 140, components 180-184, one or more timers (such as discussed with reference to FIG. 2), and sensor(s) 150, of FIG. 1. Also, the operations discussed with reference to FIGS. 1-3 may be performed by one or more components of the system 400.

A chipset 406 may also communicate with the interconnection network 404. The chipset 406 may include a graphics and memory control hub (GMCH) 408. The GMCH 408 may include a memory controller 410 that communicates with a memory 412. The memory 412 may store data, including sequences of instructions that are executed by the processor 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with the touch screen 180. In one embodiment of the invention, the graphics interface 414 may communicate with a graphics accelerator via an accelerated graphics port (AGP). In an embodiment of the invention, the touch screen 180 (which may be coupled to a display device such as a flat panel display, a cathode ray tube (CRT), a projection screen, etc.) may communicate with the graphics interface 414 through, for example, the logic 182 or another a signal converter that translates a digital representation of an image stored in a storage device such as video memory or system memory into display signals that are interpreted and displayed by a display device. The display signals produced by the display device may pass through various control devices before being interpreted by and subsequently displayed on the display device.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the processor 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and one or more network interface device(s) 430 (which is in communication with the computer network 403). Other devices may communicate via the bus 422. Also, various components (such as the network interface device 430) may communicate with the GMCH 408 in some embodiments of the invention. In addition, one or more of the components of FIG. 4 (such as the processor 402 and the GMCH 408) may be combined to form a single IC chip.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration. For example, processors, memory, and/or input/output devices may be interconnected by a number of point-to-point interfaces.

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500. For example, a voltage regulator (such as VR 130 of FIG. 1) may regulate voltage supplied to one or more components of FIG. 5.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4. Also, system 500 may include one or more of the cores 106, logic 140, components 180-184, one or more timers (such as discussed with reference to FIG. 2), and sensor(s) 150, of FIG. 1.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537. The graphics circuit 534 is in turn coupled to the display device such as discussed with reference to FIG. 1 or 4.

In at least one embodiment, one or more operations discussed with reference to FIGS. 1-5 may be performed by the processors 502 or 504 and/or other components of the system 500 such as those communicating via a bus 540. Other embodiments of the invention, however, may exist in other circuits, logic units, or devices within the system 500 of FIG. 5. Furthermore, some embodiments of the invention may be distributed throughout several circuits, logic units, or devices illustrated in FIG. 5.

Chipset 520 may communicate with the bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a tangible machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic at least a portion of which is in hardware, the logic to cause a modification to a scan rate of a touch screen based at least in part on proximity data that is to be indicative of proximity of a user to the touch screen,
wherein the proximity data is to be generated by one or more proximity sensors that are to be communicatively coupled to the logic to cause the modification to the scan rate of the touch screen.

2. The apparatus of claim 1, further comprising logic, at least a portion of which is in hardware, to analyze the proximity data to determine whether the user is proximate to the touch screen.

3. The apparatus of claim 1, wherein the logic is to cause a decrease in the scan rate in response to a determination, based at least in part on the proximity data, that no user is proximate to the touch screen.

4. The apparatus of claim 1, wherein the logic is to cause an increase in the scan rate in response to a determination, based at least in part on the proximity data, that the user is proximate to the touch screen.

5. The apparatus of claim 1, further comprising logic, at least a portion of which is in hardware, to cause the touch screen to enter a low power consumption state in response to a determination, based at least in part on the proximity data, that no user is proximate to the touch screen.

6. The apparatus of claim 5, wherein the low power consumption state is to comprise one or more of a standby state, a sleep state, a deep sleep state, and a suspend state.

7. The apparatus of claim 1, further comprising logic, at least a portion of which is in hardware, to cause the touch screen to exit a low power consumption state in response to a determination, based at least in part on the proximity data, that the user is proximate to the touch screen.

8. The apparatus of claim 7, wherein the low power consumption state is to comprise one or more of a standby state, a sleep state, a deep sleep state, and a suspend state.

9. The apparatus of claim 1, wherein the one or more proximity sensors are to comprise one or more of: infra red sensor, ultra sonic device, an image capture device, and an efield based proximity sensor.

10. The apparatus of claim 1, further comprising logic, at least a portion of which is in hardware, to cause a processor, coupled to the touch screen, to enter a low power consumption state in response to a determination, based at least in part on the proximity data, that no user is proximate to the touch screen.

11. The apparatus of claim 1, further comprising logic, at least a portion of which is in hardware, to cause a processor, coupled to the touch screen, to exit a low power consumption state in response to a determination, based at least in part on the proximity data, that the user is proximate to the touch screen.

12. The apparatus of claim 1, wherein the logic is to cause the modification to the scan rate of the touch screen based at least in part on the proximity data and expiration of a timer.

13. The apparatus of claim 1, further comprising one or more sensors to detect variations in one or more of: temperature, operating frequency, operating voltage, and power consumption.

14. The apparatus of claim 1, wherein one or more of the logic, one or more processor cores of a processor, and a memory are on a single integrated circuit.

15. A method comprising:
causing a modification to a scan rate of a touch screen based at least in part on proximity data that is indicative of proximity of a user to the touch screen,
wherein the proximity data is generated by one or more proximity sensors.

16. The method of claim 15, further comprising causing the touch screen to enter a low power consumption state in response to a determination, based at least in part on the proximity data, that no user is proximate to the touch screen.

17. The method of claim 15, further comprising causing the touch screen to exit a low power consumption state in response to a determination, based at least in part on the proximity data, that the user is proximate to the touch screen.

18. A computer-readable medium comprising one or more instructions that when executed on a processor configure the processor to perform one or more operations to:
cause a modification to a scan rate of a touch screen based at least in part on proximity data that is indicative of proximity of a user to the touch screen,
wherein the proximity data is generated by one or more proximity sensors.

19. The computer-readable medium of claim 18, further comprising one or more instructions that when executed on the processor configure the processor to perform one or more operations to cause a decrease in the scan rate in response to a determination, based at least in part on the proximity data, that no user is proximate to the touch screen.

20. The computer-readable medium of claim 18, further comprising one or more instructions that when executed on the processor configure the processor to perform one or more operations to cause an increase in the scan rate in response to a determination, based at least in part on the proximity data, that the user is proximate to the touch screen.

21. The computer-readable medium of claim 18, further comprising one or more instructions that when executed on the processor configure the processor to perform one or more operations to cause the touch screen to enter a low power consumption state in response to a determination, based at least in part on the proximity data, that no user is proximate to the touch screen.

22. The computer-readable medium of claim 18, further comprising one or more instructions that when executed on the processor configure the processor to perform one or more operations to cause the touch screen to exit a low power consumption state in response to a determination, based at least in part on the proximity data, that the user is proximate to the touch screen.

23. The computer-readable medium of claim 18, further comprising one or more instructions that when executed on the processor configure the processor to perform one or more operations to cause the processor to enter a low power consumption state in response to a determination, based at least in part on the proximity data, that no user is proximate to the touch screen.

24. The computer-readable medium of claim 18, further comprising one or more instructions that when executed on the processor configure the processor to perform one or more operations to cause the processor to exit a low power consumption state in response to a determination, based at least in part on the proximity data, that the user is proximate to the touch screen.

25. The computer-readable medium of claim 18, further comprising one or more instructions that when executed on the processor configure the processor to perform one or more operations to cause the modification to the scan rate of the touch screen based at least in part on the proximity data and expiration of a timer.

26. A system comprising:
a touch screen; and
logic at least a portion of which is in hardware, the logic to cause a modification to a scan rate of the touch screen based at least in part on proximity data that is to be indicative of proximity of a user to the touch screen,
wherein the proximity data is to be generated by one or more proximity sensors that are to be communicatively coupled to the logic to cause the modification to the scan rate of the touch screen.

27. The system of claim 26, further comprising logic, at least a portion of which is in hardware, to analyze the proximity data to determine whether the user is proximate to the touch screen.

28. The system of claim 26, wherein the logic is to cause a decrease in the scan rate in response to a determination, based at least in part on the proximity data, that no user is proximate to the touch screen.

29. The system of claim 26, wherein the logic is to cause an increase in the scan rate in response to a determination, based at least in part on the proximity data, that the user is proximate to the touch screen.

30. The system of claim 26, wherein the one or more proximity sensors are to comprise one or more of: infra red sensor, ultra sonic device, an image capture device, and an efield based proximity sensor.
